(19) United States
(12) Patent Application Publication
(10) Pub. No.: US 2022/0093282 A1
(43) Pub. Date: Mar. 24, 2022

(54) Nuclear Power Generation using a Thorium Molten Salt Reactor with a Compact Thermal Neutron Generator

(71) Applicant: Kyunam Choi, Fullerton, CA (US)

(72) Inventor: Kyunam Choi, Fullerton, CA (US)

(21) Appl. No.: 17/026,229

(22) Filed: Sep. 20, 2020

(51) Int. Cl. G21D 3/08; G21C 5/12; G21C 7/34; G21D 1/02

(52) U.S. Cl. CPC G21D 3/08; G21D 1/02; G21C 7/34; G21C 5/123

(57) ABSTRACT

This patent application is for a process of nuclear power generation with ˜KW output by making the Thorium fuel of LiF+BeF₂+ThF₄ in a Thorium Molten Salt Reactor (Th-MSR) to undergo fission along the thorium fuel cycle by providing thermal neutrons which were obtained by slowing down of fast neutrons from n external neutron generators with the help of graphite moderators carefully arranged inside the Th-MSR.

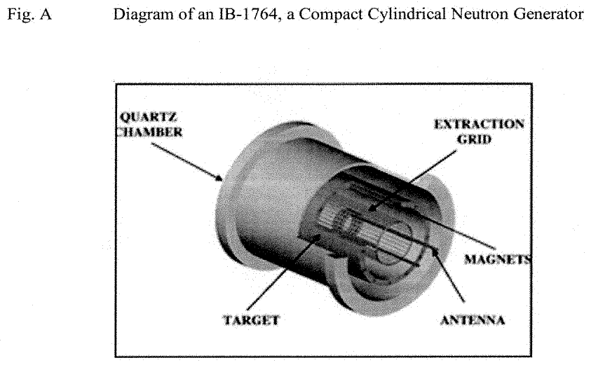

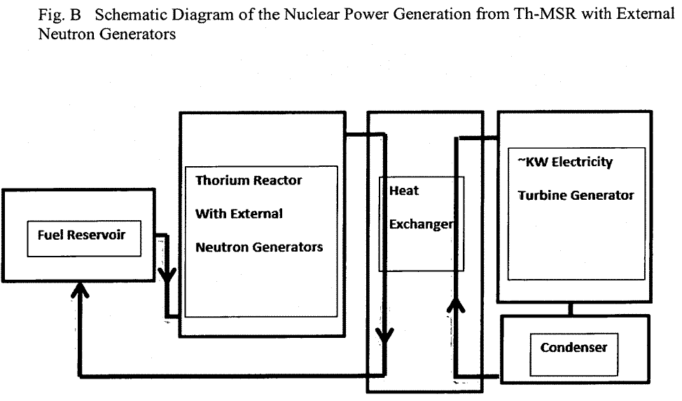

The molten salt that entered the reactor at a temperature of 600° C. becomes hot to 750° C. due to nuclear fission, goes through a heat exchanger and returns to the reactor. The output power of this reactor is proportional to the number of thermal neutrons supplied to the inside of the reactor, and when the external neutron generator is turned ON-OFF, nuclear power generation is also ON-OFF.

This Th-MSR power generation process with thermal neutron generators, which Dr. Choi is applying for a patent, will be one of the most innovative ways to generate ˜kW range nuclear power with the use of 100% non-radioactive nuclear fuel since until now all the Th-MSR power generation scheme relied upon neutrons from the natural decay of Uranium-235 mixed with the Thorium fuel of LiF+BeF₂+ThF₄ with a mixing ratio of 80% ThF4 to 20% UF4.
Key Word Thorium Molten Salt Reactor, Thermal Neutron Generator

### BACKGROUND OF THE INVENTION

There are three fissionable elements that can be used as nuclear fuel: Thorium, Uranium, and Plutonium. U-235 and Pu-239 spontaneously decay to emit neutrons which sustain the fuel cycle. Thorium-232 does not decay spontaneously. Therefore, it is necessary to supply neutrons to sustain the Thorium fuel chain.

In 1965, ORNL mixed Th-232 and U-235 at 80:20 ratio in the Thorium Molten Salt, LiF—BeF₂—ThF₄ (or UF₄), so that fast neutrons from the natural decay of uranium generated inside the reactor slowed down into thermal neutrons after passing through moderators carefully distributed and arranged inside the reactor to sustain the thorium fuel cycle¹ and obtained ˜7 MW output until 1970. Then the Th-MSR Program at ORNL was terminated by Nixon Administration and classified as secret until 2005. ¹The thorium fuel cycle develops in the following order: When Thorium-232 encounters a neutron, it becomes Thorium-233, Th-233 with a half-life of 22 minutes becomes Protactinium-233 after beta decay, Protactinium-233 with a half-life of 27 days becomes Uranium-233 after beta decay. When this Uranium-233 collides with a thermal neutron, it causes nuclear fission, splitting into two atoms, generating fission energy of 198 MeV and fast neutrons.

After the secret was released, Th-MSR nuclear power generation was carried out at research centers in the US, China, Japan, India, EU and so on. Each time ˜20% of Uranium-235 was mixed into Th-MSR fuel as a neutron source.

The core of this patent is to use an external neutron generator as a neutron source while using Thorium fuel without any U-235 mixed into it.

How Many Thermal Neutrons Are Needed for 1 KW Power Generation

With the assumption that we can convert most of the fast neutrons into thermal neutrons with energy less than 0.025 eV using moderators carefully placed inside the reactor, we can do some calculations to create a Th-MSR that produces 1 kW of power.
1. The number of U-233 atoms required to produce 1 Watt of power is 3.1522×10¹⁰ per second since one atom emits 198 MeV (=3.1723×10⁻¹¹ Joule). Therefore, the number of U-233 atoms required to produce 1 KW output is 3.1522×10¹³ per second, which is the same as the number of thermal neutrons required for 1 KW power generation.
2. The output power of the Th-MSR with an external neutron source, the method proposed in this patent, is proportional to the number of thermal neutrons supplied.
3. There are a variety of neutron generators that can be used as an external neutron source for Th-MSR. They are:
   (a) Neutron generator using a linear accelerator pursued by EU researchers.
   (b) Semiconductor neutron generators named “neutristor” by Sandia National Lab.
   (c) Tube type neutron generators for airport security inspection systems and oil drilling.
   (d) IB-1764, which a US patent² was issued in 2002 to Berkley Lab Technology of UC Berkley, is a cylindrical RF excitation plasma ion neutron generator. Fig. A is a diagram of an IB-1764, a Compact Cylindrical Neutron Generator. ² https://ipo.lbl.gov/lbn|1764/ U.S. Pat. No. 6,907,097

The neutron generator IB-1764 developed by Prof Ka-Ngo Leung of UC Berkeley can be improved to produce 1×10¹³ neutrons with 2.2 MeV energy per second through D-D reaction, and 1×10¹⁵ neutrons per second in case of D-T reaction. IB-1764 is an ideal candidate for an external Neutron Generator for a Th-MSR with 1˜10 KW output power.

This Th-MSR nuclear power generation scheme with external thermal neutron generators such as IB-1764 with Graphite moderators may be able to provide the thermal neutron flux of 1×10¹³ n/sec (for D-D) or 1×10¹⁵ n/sec (for D-T) which are numerous enough to cause sufficient nuclear fission along the Thorium fuel cycle.

### SUMMARY OF THE INVENTION

This patent petition is for a process of obtaining nuclear energy by introducing thermal neutrons inside a Thorium Molten Salt Reactor (Th-MSR) in which thorium molten salt (LiF+BeF₂+ThF₄ with a Mole % of 72:16:12) at 600° C. is flowing. The thermal neutrons hitting the molten salt in the thorium reactor causes fission, hence, nuclear power is produced by Thorium atoms undergoing nuclear transition along the thorium fuel cycle.

The thorium molten salt that entered the reactor at a temperature of 600° C. is heated to 750° C. due to nuclear fission generated by the thermal neutrons supplied from the compact cylindrical neutron generator, comes out, goes through a heat exchanger and generate steam for turbine generator, and returns to the reactor cooled down to 600° C. Steam generated from the heat exchanger enters the 1˜10 KW turbine generator to generate electrical power and returns to the heat exchanger via a condenser. A schematic diagram of the nuclear power generation from a Th-MSR with an external neutron generator is shown in Fig. B.

The output power of this reactor is proportional to the number of thermal neutrons supplied to the molten salt in the reactor, and when the thermal neutron generator is turned ON-OFF, nuclear power generation is also turned ON-OFF. Nuclear power output can be controlled by adjusting the RF excitation voltage supplied to the external neutron generator. Fission process in Th-MSR automatically stops if the temperature of the fuel salt goes over a certain limit (e.g., 850° C.) since the expanded molecular distance prohibits nuclear fission. Therefore, the system will be free from thermal runaway. Also, there is no risk of explosion since the whole system operates at 1 atmospheric pressure.

Nuclear power generation from a thorium molten salt reactor with external neutron generators for which Dr. Kyunam Choi is applying for a U.S. patent will be one of the most innovative ways to realize ˜KW power nuclear power generation using currently established technologies and without using any radioactive material such as U-235 or Pu-239 mixed into the Th-MSR fuel.

### BRIEF DESCRIPTION OF DRAWINGS

Fig. A Diagram of an IB-1764, a Compact Cylindrical Neutron Generator

Fig. B Schematic Diagram of Nuclear Power Generation from Thorium Molten Salt Reactor (Th-MSR) with External Neutron Generators

What is claimed is:

1. To maintain the Thorium fuel chain in Thorium Molten Salt Reactors (Th-MSR), neutrons from external neutron generators are supplied into the Th-MSR with Thorium fuel of LiF+BeF₂+ThF₄ without any U-235 mixed into it, in contrast to the conventional method of mixing Uranium-235 in the form of UF₄ mixed into the Thorium fuel to utilize neutrons emitted from the natural decay of U-235 as neutron source.
